(19) United States
(12) Patent Application Publication
(10) Pub. No.: US 2008/0177421 A1
(43) Pub. Date: Jul. 24, 2008

(54) ROBOT AND COMPONENT CONTROL MODULE OF THE SAME

(75) Inventors: Hua-Dong Cheng, Shenzhen City (CN); Tsu-Li Chiang, Shenzhen City (TW); Han-Che Wang, Shenzhen City (CN); Kuan-Hong Hsieh, Shenzhen City (CN); Xiao-Guang Li, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/972,627

(22) Filed: Jan. 11, 2008

(30) Foreign Application Priority Data
Jan. 19, 2007 (CN) 200710200086.2

(51) Int. Cl. G05B 15/00

(52) U.S. Cl. 700/245; 901/1; 901/2; 901/46

(57) ABSTRACT

A robot and its component control module are disclosed. The robot includes a CPU and at least two component modules. Each component control module includes at least one actuator, at least one sensor, and a controller. The sensor is used for detecting outside information and correspondingly generating a sensing signal. The controller receives the sensing signal, controls the actuator to perform an action according to the sensing signal and sends the sensing signal to the CPU. The CPU receives the sensing signal, gets the outside information associated with the sensing signal, generates action instruction according to the outside information, and sends out the action instruction to the corresponding component control module. The controller of the corresponding component control module controls the actuator of the component control module to perform an action according to the action instruction. The robot responds quickly to outside information.

### BACKGROUND

1. Technical Field

The present invention relates to robots, and particularly, to component control modules of robots.

2. General Background

Pet robots are becoming popular toys nowadays. Pet robots are made to look like and imitate dogs, cats, dinosaurs, and so on. However, one disadvantage of pet robots is that they respond slowly to outside information.

An example of pet robots is shown in FIG. 1. The pet robot is a dinosaur 50.

The dinosaur 50 acquires outside information by sensors which are located all over the body thereof, and acts by actuators which are connected to joints of the body. The sensors and the actuators are located as follows: each leg includes an actuator 110 located on an upper end for controlling the leg to rotate, an actuator 111 located on the ankle for allowing movement of the feet, a touch sensor 112, and a press sensor 113 located on the sole of the feet; the tail includes an actuator 120 for controlling the tail to rotate vertically, an actuator 121 for controlling the tail to rotate horizontally, and a touch sensor 122; the back includes an actuator 130; the neck includes an actuator 140 for controlling the neck to rotate vertically, an actuator 141 for controlling the neck to rotate horizontally, a touch sensor 142, and two sound sensors 143; the head includes an actuator 150, a touch sensor 152, and an image sensor 154.

A control system of the dinosaur 50 is disclosed in FIG. 2. The dinosaur 50 includes a CPU (central processing unit) 56, a plurality of controllers 61 (only two controllers 61 are shown in FIG. 2), a plurality of actuators 72 (only two actuators 72 are shown in FIG. 2), and a memory 73. The CPU 56 connects with the controllers 61 and the actuators 72. Each controller 61 connects with a plurality of sensors 62. The actuators 72 are not unlike the actuators 110, 111, 120, 121, 130, 140, 141, 150 mentioned in FIG. 1. The sensors 62 are not unlike the sensors 112, 113, 122, 142, 143, 152, 154 mentioned in FIG. 1. The actuators and the sensors are respectively referred to by single reference in FIG. 2 so that the control system of the dinosaur 50 can be concisely presented.

The memory 73 stores the dinosaur 50's action instructions, status information, and relationships between outside information, the status information and action instructions, etc. According to an action instruction, the CPU 56 can produce a plurality of sub-action instructions and control corresponding actuators 72 to perform an action. The outside information is detected by sensors 62, includes light signals, touch signals or sound signals, etc. The status information represents the dinosaur 50's status, includes resting, moving, etc.

The sensors 62 detect outside information and send out detection results as sensing signals to controllers 61. The controllers 61 send the sensing signals to the CPU 56. The CPU 56 gets the outside information on the basis of the sensing signals, gets the current status information from the memory 73, gets an action instruction from the memory 73 according to the outside information and the current status information, produces sub-action instructions according to the action instruction, and controls corresponding actuators 72 to perform an action according to the sub-action instructions. The CPU 56 deals with too much information and as a result is usually slow to respond to a sensing signal. Thus, the dinosaur 50 responds slowly to outside information.

Therefore, what is needed is a robot which responds quickly to outside information.

### SUMMARY

A robot and it's component control module are disclosed. The robot includes a CPU and at least two component modules. Each component control module includes at least one actuator, at least one sensor, and a controller. The sensor is used for detecting outside information and correspondingly generating a sensing signal. The controller receives the sensing signal, controls the actuator to perform an action according to the sensing signal and sends the sensing signal to the CPU. The CPU receives the sensing signal, gets the outside information associated with the sensing signal, generates action instruction according to the outside information, and sends out the action instruction to the corresponding component control module. The controller of the corresponding component control module controls the actuator of the component control module to perform an action according to the action instruction.

Further features and advantages will be provided or will become apparent in the course of the following detailed description.

### BRIEF DESCRIPTION OF THE DRAWINGS

The components of the drawings are not necessarily drawn to measuring scale, the emphasis instead being placed upon clearly illustrating the principles of the robot. Moreover, in the drawings, like reference numerals designate corresponding parts throughout the several views.

FIG. 1 is a schematic, front view of a pet robot with sensors and actuators located thereon according to a prior art.

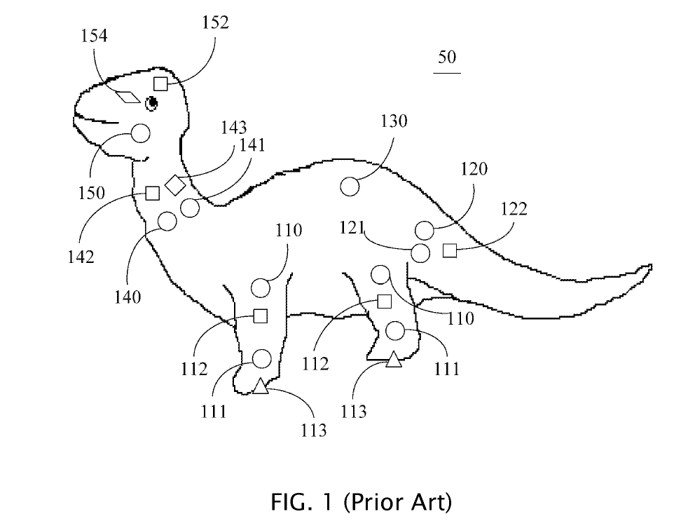

FIG. 2 is a block diagram of a hardware infrastructure of the pet robot of FIG. 1.

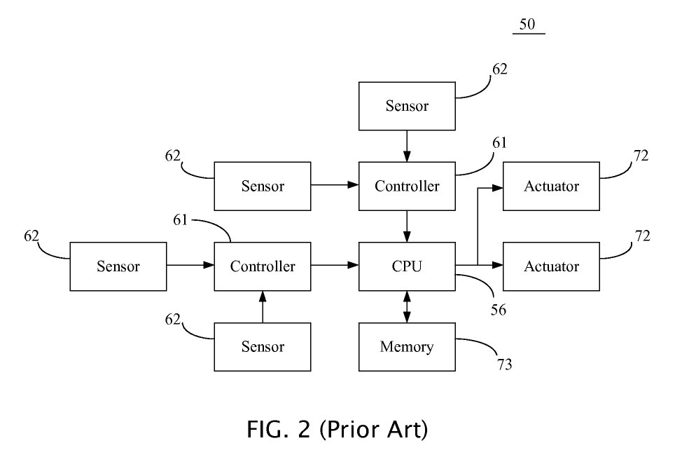

FIG. 3 is a block diagram of a hardware infrastructure of a robot according to a preferred embodiment of the present invention.

FIG. 4 is a block diagram of a hardware infrastructure of a component control module of the robot of FIG. 3.

FIG. 5 is a data flowchart of a control process of the robot of FIG. 3.

### DETAILED DESCRIPTION OF THE EMBODIMENT

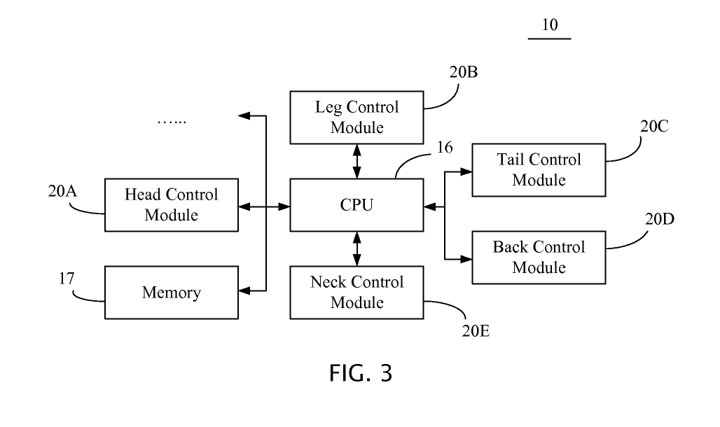

Referring to FIG. 3, a robot according to a preferred embodiment of the present invention is disclosed. The robot 10 can be an electronic dog, an electronic cat, an electronic dinosaur, etc. The robot 10 includes a central processing unit (CPU) 16 and a plurality of component control modules 20. The component control modules 20 are electrically connected with the CPU 16. The component control modules 20 includes, but not limited to, a head control module 20A, four leg control modules 20B, a tail control module 20C, a back control module 20D, and a neck control module 20E.

The robot 10 also includes a memory 17 electrically connected with the CPU 16. The memory 17 stores action instructions, status information, and outside information. The outside information are inputs from the surrounding environment and can be in the form of, for example, sound, pressure, light, etc. The status information includes various statuses of the robot 10, for example, resting, moving, etc. The action instructions are used for controlling several component control modules 20 in coordination to accomplish an action. Each of the action instructions is composed of a plurality of sub-action instructions. Each of the sub-action instructions is used for controlling a component control module 20. The memory 17 further stores relationships associated with the outside information, the status information, and the action instructions.

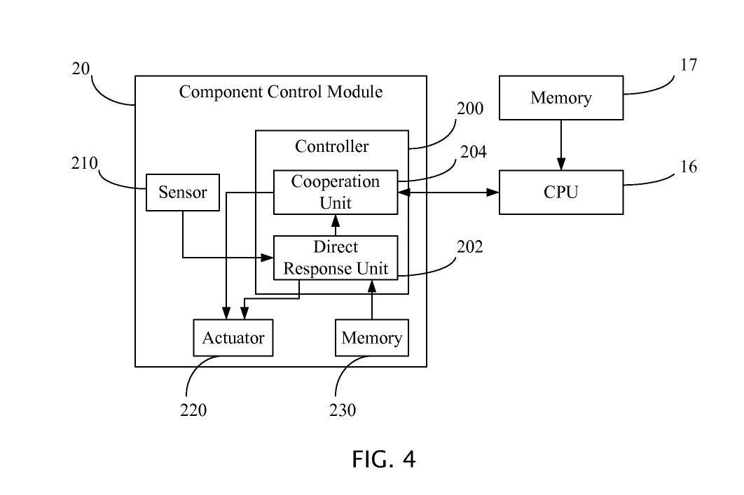

Referring to FIG. 4, a block diagram of a hardware infrastructure of the component control module 20 is disclosed. The component control module 20 includes a controller 200, at least one sensor 210, at least one actuator 220, and a memory 230. The controller 200 includes a direct response unit 202 and a cooperation unit 204. The sensor 210 is configured for generating a sensing signal when detecting the outside information. The memory 230 stores one or more response instructions and relationships associated with the sensing signals and the response instructions. Direction response instructions of the head control module 20A are configured for controlling actions of the head of the robot 10, direction response instructions of the leg control module 20B are configured for controlling actions of legs of the robot 10, and so on.

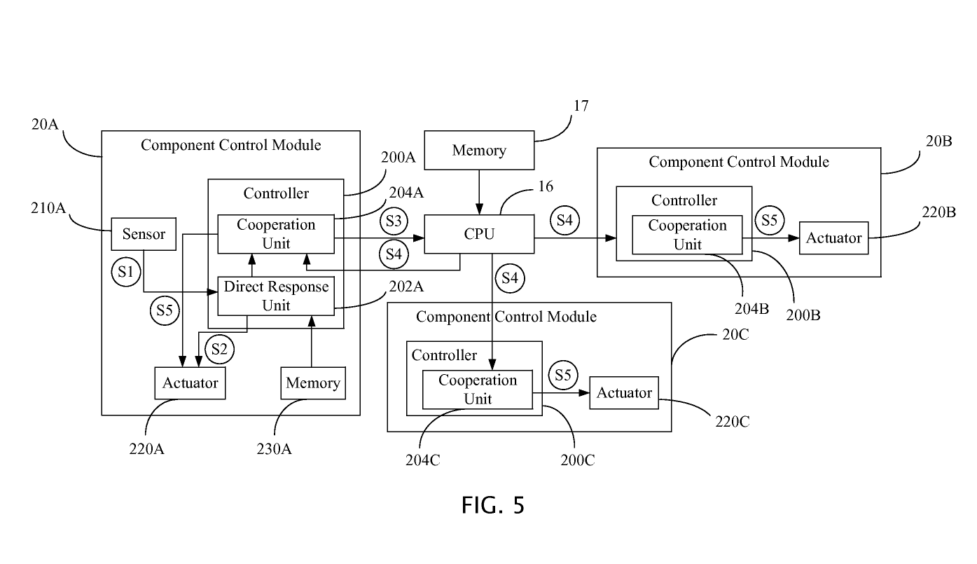

Referring to FIG. 5, a data flowchart of a control process of the robot 10 is shown. In order to concisely present the control process, only components and references that are mentioned below are shown in FIG. 5.

In step S1, when detecting the outside information, the sensor 210A generates the sensing signal and sends the sensing signal to the direct response unit 202A. In step S2, the direct response unit 202A receives the sensing signal, gets a response instruction corresponding to the sensing signal from the memory 230A, and controls actuators 220A to perform an action according to the response instruction. In step S3, the cooperation unit 204A sends the sensing signal to the CPU 16. In step S4, the CPU 16 gets the outside information on the basis of the sensing signal, reads a current status information from the memory 17, reads an action instruction from the memory 17 associated with the outside information and the current status information, produces a plurality of sub-action instructions according to the action instruction, and sends the sub-action instructions to the corresponding component control modules 20A, 20B, or 20C. In step S5, the cooperation unit 204A, 204B, or 204C of component control module 20A, 20B, or 20C receives the sub-action instructions, and controls the actuator 220A, 220B, or 220C to perform actions according to the sub-action instructions.

A detailed control process in accordance with a preferred embodiment of the present invention is described below.

The response instructions in the memory 230A include “raise head” and “turn head to the direction of the sound” corresponding to a sound signal. The action instructions stored in the memory 17 include “stand up”, “walk towards the place of a sound source”, and “wag tail” corresponding to a sound signal of “come here” and a current status information of “resting”.

If the current status information of the robot 10 is “resting”, and a user gives a sound signal of “come here” in front of the robot 10, the sound sensor 210A detects the sound signal and sends a sensing signal to the direct response unit 202A. According to the sensing signal, the direct response unit 202A get the response instructions of “raise head” and “turn head to the direction of the sound” from the memory 230A, and controls actuators 220A to perform an action correspondingly.

The cooperation unit 204A sends the sensing signal to the CPU 16. The CPU 16 gets the outside information on the basis of the sensing signal. The outside information is the sound signal of “come here”. The direction of the sound signal is in front of the robot 10. The CPU 16 gets the current status information of “resting” from the memory 17, gets the corresponding action instructions of “stand up”, “walk ahead”, and “wag tail”, produces a plurality of sub-action instructions according to the action instructions, and sends out the sub-action instructions to the corresponding component control modules 20, the component control modules 20 cooperate to accomplish the actions of “stand up”, “walk ahead”, and “wag tail”.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A component control module of a robot, wherein the robot comprises a CPU, the component control module comprising:
at least one actuator;
at least one sensor for generating a sensing signal when detecting outside information; and
a controller, electrically connected with the CPU, the actuator and the sensor, configured for receiving the sensing signal, controlling the actuator to perform an action according to the sensing signal, and sending the sensing signal to the CPU.

2. The component control module of claim 1, wherein the controller further receives an action instruction from the CPU, and controls the actuator to perform an action according to the action instruction.

3. A robot comprising:
at least two component control modules, each component control module comprising:
at least one actuator;
at least one sensor for generating a sensing signal when detecting outside information; and
a controller, configured for receiving the sensing signal, controlling the actuator to perform an action according to the sensing signal, and sending sensing signal; and
a CPU connected with the controller of each component control module, wherein the CPU receives the sensing signal, gets the outside information associated with the sensing signal, generates action instructions according to the outside information, and sends out the action instructions to the corresponding component control modules, the controllers of the corresponding component control modules control the actuators of the component control modules to perform an action according to the action instructions.

4. The robot of claim3, wherein the robot comprises a head, a neck, a back a tail and four legs, the component control module is one of the head control module, the neck control module, the back control module, the tail control module or the leg control module.

5. A robot comprising:
a CPU;
a first memory for storing action instructions, status information and relationships associated with outside information, the status information and the action instructions; and
at least two component control module comprising:
at least one actuator;
at least one sensor for detecting the outside information and correspondingly generating a sensing signal;
a second memory for storing at least one response instruction and relationships associated with the sensing signal and the response instruction;
a controller, configured for receiving the sensing signal, reading the corresponding response instruction associated with the sensing signal from the second memory, controlling the actuator to perform an action according to the response instruction, and sending the sensing signal; wherein
the CPU receives the sensing signal, gets the outside information associated with the sensing signal, reads action instruction from the first memory according to the outside information and the current status information, and sends the action instruction to the corresponding component control module, the controller of the corresponding component control module controls the actuator of the component control module to perform an action according to the action instruction.

6. The robot of claim5, wherein the robot comprises a head, a neck, a back a tail and four legs, the component control module is one of the head control module, the neck control module, the back control module, the tail control module or the leg control module.
